(19) United States
(12) Patent Application Publication
(10) Pub. No.: US 2017/0029625 A1
(43) Pub. Date: Feb. 2, 2017

(54) IMPACT INDICATOR COATINGS AND METHODS

(71) Applicant: P.H. Glatfelter Company, York, PA (US)

(72) Inventors: John W. Stolarz, JR., Circleville, OH (US); William N. Justice, Waverly, OH (US)

(21) Appl. No.: 15/222,222

(22) Filed: Jul. 28, 2016

Related U.S. Application Data
(60) Provisional application No. 62/198,941, filed on Jul. 30, 2015.

(51) Int. Cl. C09D 5/00; C09D 7/12; A63B 53/04; B41M 5/136; B41M 5/155; G01L 1/24; C09D 7/00; B41M 5/165

(52) U.S. Cl. CPC C09D 5/00; C09D 7/007; C09D 7/1291; B41M 5/165; B41M 5/136; B41M 5/155; G01L 1/247; A63B 53/04; A63B 2053/002

(57) ABSTRACT

Impact indicator compositions, application devices, and methods comprising coating a surface to be impacted, wherein the coating comprises microcapsules having a cross-linked polyurea shell and a core surrounded by the shell, the core comprising at least one color former; and a developer capable of activating the color former when in contact therewith.

### CROSS-REFERENCE TO RELATED APPLICATION

This application claims priority under 35 U.S.C. §119(e) to U.S. Provisional Patent Application Ser. No. 62/198,941, filed on Jul. 30, 2015, which is hereby incorporated by reference in its entirety.

### FIELD

This patent document relates in general to a coating that may be applied to an object or material and which will activate upon forceful impact by a second object to provide a precise visual determination of the point or area of impact. In particular, this patent document pertains to a spray-on coating that can be applied to a variety of surfaces and which will activate upon impact to give a visual determination by color change of the precise area and/or degree of force of impact.

### BACKGROUND

In the case of golfing, the objective is to strike the ball near the middle of the club face to obtain maximum distance/performance. Striking outside of this area, the golfer may encounter what is commonly referred to as a slice or hook. By knowing exactly where the ball impacted the club face, the golfer can make adjustments to correct their swing, thereby using the “sweet spot” of the golf club face and improving their game. This problem is not unique to golf, as other sports can likewise benefit from knowing the location of where two objects made contact, such as baseball, tennis, and cricket.

Current products on the market typically involve a talc or a self-contained tape that is adhered to the club face. Disadvantages or drawbacks associated with each include having to re-apply the talc or replace the tape after each swing. The exact point of impact can also be difficult to distinguish as talc adjacent to the impact area may also detach, while a club strike with the tape may occur at the outer boundary/edge, thereby showing only a small portion of the hit.

While the existing systems and methods are useful to a degree, they still suffer from certain drawbacks. Therefore, there exists a need in the art for improved materials and methods that can be applied to a variety of surfaces that will self-image upon impact.

### SUMMARY OF THE EMBODIMENTS

Compositions for coatings that will activate upon impact to provide a visible color change indicating precise aspects of the impact and methods of making and using such coatings are disclosed herein.

As described more fully below, the compositions and processes of the embodiments disclosed herein permit improved systems and methods for a conveniently applied, e.g., spray-on, coating that will activate upon impact. Further aspects, objects, desirable features, and advantages of the products and methods disclosed herein will be better understood and apparent to one skilled in the relevant art in view of the detailed description and drawings that follow, in which various embodiments are illustrated by way of example. It is to be expressly understood, however, that the description and drawings are for the purpose of illustration only and are not intended as a definition of the limits of the claimed embodiments.

To this end, an impact indicator application device comprising a container is provided, wherein the container, such as bottle or can, comprises an impact indicator coating; the impact indicator coating comprises, in one embodiment about 15-25% by weight microcapsules having a cross-linked polyurea shell and a core surrounded by the shell, wherein the core comprises at least one color former dissolved in a carrier oil; about 15-20% by weight developer particles; about 40-60% pigment; about 5-20% binder; and about 50-70% water. This is an aqueous, liquid coating. A minority component, such as less than 5%, of surfactant-type foam control agents may be added for more desirable delivery of the spray performance to the working area of the impact surface. The container may be, for example, a spray can and the coating material in liquid sprayable form.

In one form, a method of treating a user device to reveal a contact location is provided, the method comprising providing a first device, wherein the device comprises at least one surface on which an impact indictor coating may be applied; applying the impact indicator coating to at least one surface of the device by spraying the coating, wherein the impact indicator comprises microcapsules with a color former, and a developer; and optionally activating the impact indicator coating by causing or permitting an impact from a second surface or device on the surface of the first device, thus causing a visual color change mark to appear on the surface of the device. Such visual mark on the surface of the first device provides a precise indication of the area and/or degree of the impact.

The coating includes microcapsules having a cross-linked polymer shell and a core surrounded by the shell. The cross-linked polymer shell may be comprised of, for example, a polyurea. The core surrounded by the polymer shell may be comprised of color former dissolved in, for example, a carrier oil. The color former may include leuco dyes, for example. The carrier oil may include a vegetable oil, soybean oil, or the like. In one embodiment, the coating may contain about 15-25% by weight of the microcapsules.

The microcapsules are preferably of a size and thickness designed to remain intact under the normal handling but able to rupture when a force is applied to the microcapsules (e.g., by swinging a golf club to drive a golf ball). As an example, microcapsules having a diameter of about 2-8 microns, and in particular, about 5 microns, and having a wall thickness of about 110-120 nanometers exhibit a sufficient rupture strength to allow for the microcapsules to remain intact during normal handling, but which rupture when such a force is applied to the surface.

The coating may include developer particles. The developer particles may include any developers capable of reacting with the color former inside the microcapsules when released by rupturing the microcapsules to produce a visible color image. For example, the developer may include a phenolic resin, such as a zincated phenolic resin, In one embodiment, the coating may contain about 15-20% by weight of developer particles.

The coating may be colorless or colored when in an unreacted state (i.e., so long as the at least one color former is not in contact with the developer particles). In one embodiment, the coating may include (a) about up to about 35%, 5-35%, 10-30%, or 15-25% by weight microcapsules having a cross-linked polyurea shell and a core surrounded by the shell, wherein the core comprises at least one color former dissolved in a carrier oil; (b) up to about 30%, 5-30%, 10-25%, or 15-20% by weight developer particles; (c) up to about 70%, 30-70%, 35-65%, or 40-60% pigment; (d) up to about 30%, 3-30%, 4-25%, or 5-20% binder; and (e) up to about 80%, 40-80%, 45-75%, or 50-70% water.

Also provided are impact indicator compositions, comprising microcapsules having a cross-linked polyurea shell and a core surrounded by the shell, wherein the polyurea shell comprises at least one isocyanate and at least one polyamine, and the core comprises at least one color former; and a developer capable of activating the color former when in contact therewith; wherein the microcapsules are configured to remain intact during application upon a first surface to be coated, and to rupture upon impact between the first surface and another surface thereby releasing the color former to contact the developer and provide a visual indication of location of the impact. The core preferably comprises the at least one color former dissolved in a carrier oil. The color former is preferably a leuco dye.

The impact indicator composition microcapsules may have any suitable diameter, for example, about 2-8 microns, and wall thickness of, for example, about 110-120 nanometers. The developer may be in the form of particles. The developer preferably comprises a phenolic resin. The composition may further comprises a pigment, such as about 40-60% pigment, and/or a binder, for example about 5-20% binder.

The impact indicator composition may be, such as, an aqueous liquid comprising about 5 to 35% by weight microcapsules having a cross-linked polyurea shell and a core surrounded by the shell, wherein the core comprises at least one color former dissolved in a carrier oil; 5 to 30% by weight developer particles; and about 3 to 30% binder. In a particular embodiment, the isocyanate comprises a bis-isocyanate and the polyamine comprises guanidine.

Also provided are devices for precisely indicating an impact location, comprising a container; and a liquid impact indicator composition within the container; wherein the impact indicator composition comprises microcapsules having a cross-linked polyurea shell and a core surrounded by the shell, wherein the core comprises at least one color former dissolved in a carrier oil; and a developer material capable of activating the color former when in contact therewith. The device may further comprise a pump or aerosol spray nozzle configured to spray the composition. The impact indicator composition may further comprise a foam control agent. The developer preferably comprises phenolic resin particles. The core preferably comprises the at least one color former dissolved in a carrier oil, wherein the color former is, for example, a leuco dye. The device may contain microcapsules having a diameter of, for example, about 2-8 microns and a wall thickness of, for example, about 110-120 nanometers.

Also provided are methods of indicating a contact location, comprising: applying an impact indicator composition to at least a portion of a first surface; wherein the impact indicator composition comprises microcapsules having a cross-linked polyurea shell and a core surrounded by the shell, wherein the core comprises at least one color former dissolved in a carrier oil; and developer particles capable of activating the color former when in contact therewith. Preferably the applying is by spraying a coating of the composition on at least a portion of the first surface. Further provided are methods of indicating a contact location comprising activating the impact indicator composition by causing or permitting an impact from a second surface on the first surface causing a visual color change to appear on the first surface, and also compositions, devices, and methods for indicating a relative force of impact wherein the composition comprises a plurality of different microcapsules carrying different color formers and capable of rupturing at different pre-determined impact forces.

### BRIEF DESCRIPTION OF THE DRAWINGS

FIG. 1 illustrates a front view of an embodiment of the present patent document.

FIG. 2 illustrates a method of using a sprayable impact indicator according to the present patent document.

### DETAILED DESCRIPTION OF THE EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

To overcome the drawbacks associated with the current products and methods for impact indication, the present patent document offers a user friendly coating that shows the precise location of the impact, and can be used multiple times before having to be reapplied.

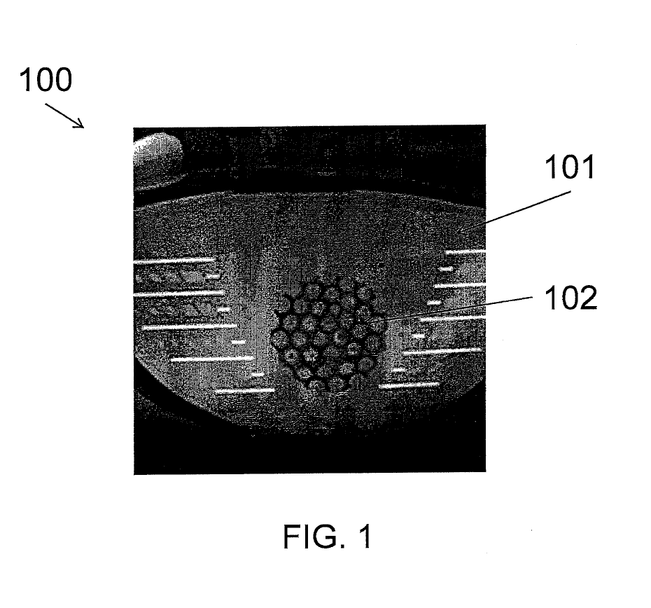

Referring to FIG. 1, there is shown a front view of an embodiment of the present patent document. The device 100 is a golf club with a golf club face 101, showing an impact indicator mark 102. The impact indicator mark 102 visually appears after the a golf ball (not shown) is hit with the golf club 100, where the golf club face 101 contacts the golf ball with a sufficient amount of force to activate the impact indicator that was previously sprayed or otherwise applied onto the golf club face 101. This coating may be used to improve performance of a golfer's swing and technique by determining where on the golf club face that the golf ball is striking.

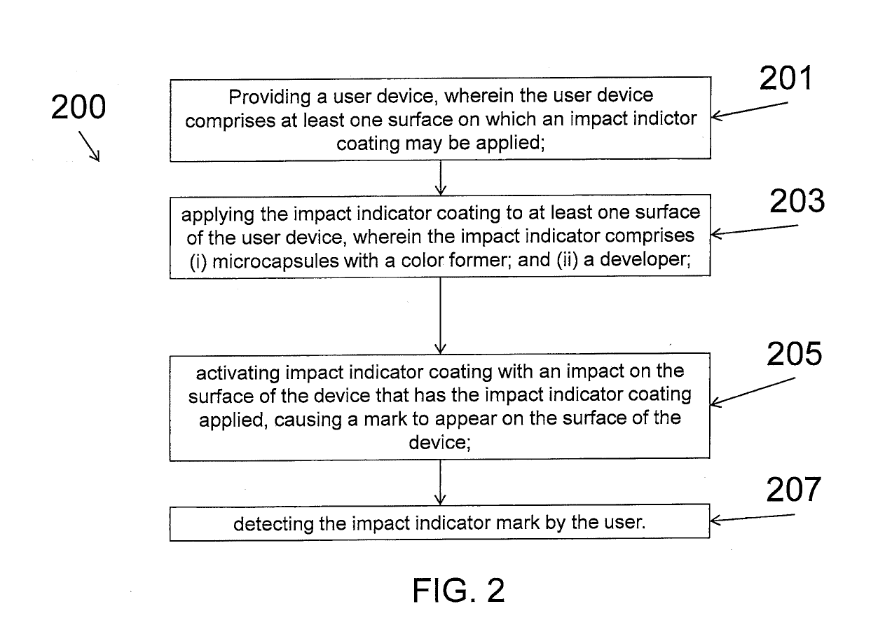

Referring now to FIG. 2, an embodiment of a method 200 is shown. FIG. 2 illustrates a method 200 of using a spray-on impact indicator coating according to one aspect of the present patent document. In block 201, a user device is provided, wherein the user device comprises at least one surface on which an impact indictor coating may be applied. In block 203, the impact indicator coating is applied to at least one surface of the user device, wherein the impact indicator comprises (i) microcapsules with a color former; and (ii) a developer. In block 205, the user device is used according to its function such that an impact occurs on the surface of the device that has the impact indicator coating applied, causing a mark to appear on the surface of the device. In block 207, the impact indicator mark is observed or detected by the user.

While in certain embodiments the impact indicator is sprayed on a device, the impact indicator may be applied by any known method such as spraying, brushing, dipping, or any other method that sufficiently applies a coating of the impact indicator composition to a device.

The present patent document relates to a coating that can be applied to a variety of surfaces such as a golf club face and will activate (self-image) upon impact. Multiple impacts can be made before having to reapply the coating. The coating may include, for example, a carbonless developer, encapsulated color former, a pigment, and a binder. Upon impact, color development will take place by way of rupturing the encapsulated color former payload, which in turn reacts with the developer resulting in an image (spot or mark) being created. In some embodiments, the pigment provides a background for the image while the binder serves to adhere the coating to the surface.

Pigments include, but are not limited to:
Kaolin clays
Calcium carbonates: ground and precipitated
Titanium dioxide
Silicas and silicates
Organics
Binders include, but are not limited to:
Starch
Polyvinyl alcohol
Styrene butadiene latex
Acrylics
Proteins
Cellulosic binders

Since the coating is applied directly to the surface of the desired object (such as a club or bat), no substrate is required as is the case with tape products, although a separate substrate may be used, if desired. The coating can be directly applied by various methods including pump and aerosol sprays. In a certain embodiments, once the impact indicator coating is applied, the coating dries quickly to an opaque, off white color, and color development from the impact will be orange. Any of a wide variety of other colors may be used. The coating is easily applied and, in the case of aqueous bases, readily washes off with water.

The preferred embodiment of the impact indicator is based on an aqueous coating. However, an oil based alternative may be used as well. Various color formers and developers may be used to achieve a wide gamut of developed colors. The capsule construction may also be varied (capsule chemistry, wall thickness, solvent, etc.). Loadings of components may be varied so long as an adequately visible color intensity is achieved. Fragrance may be used with or added to the product, such as a microencapsulated fragrance that bursts aroma upon breaking of the capsules with impact of the ball or second object.

Although the present patent document is directed in part to sporting equipment, the impact indicator may also be used in other applications and venues such as determining if damage has occurred to sensitive items due to contact during shipment, or in any other situations where observing the impact location or force of impact between two objects is desired. The premise is to give the end user a visual indication that an impact and/or damage may have occurred.

Another advantage of the impact coating disclosed herein is that the determination of the impact location is precise, providing good definition of the mark on the surface that an object has come into contact with. The impact indicator coating exhibits good surface definition of the strike when struck or activated. For example, upon striking a golf ball, one embodiment of the coating applied to the golf club face is able to show the dimples or circular recesses associated with the ball, as seen in FIG. 1.

The impact coating may also be used in a variety of other applications, such as transport of relatively fragile materials or shipment of, e.g., sensitive electronic equipment, or any other items susceptible to malfunction or premature failure if damaged by impact. In these instances, color development from the coating occurring on the material, packaging or outer shell of the product would indicate the item has sustained an impact, and should be evaluated for damage before being used.

Additional methods and uses include such as manufacturing facilities with geared machinery, or those needing to determine the amount of squeeze (nip) between two pressure points, including methods of testing the force balance across the nip of two machinery rollers mated together to ensure the force is uniformly distributed across the face of the contact area, and testing the seal integrity for leaks on doors and windows in buildings and vehicles. The indicator coating can be applied such as sprayed onto gears to determine if they are bottoming out, thereby accelerating wear. When sprayed on pressure points such as two rollers, the amount of contact between the two can be easily determined, for example detecting contact damage to missile shells. Other impact sporting goods applications include ball bats, football helmets, and racquets, and particularly sports training equipment.

Coating

The coating includes (i) microcapsules having a cross-linked polymer shell and a core surrounded by the shell; and (ii) developer materials which may, for example, be in the form of particles. The cores of the microcapsules include at least one color former dissolved in a carrier oil. If the microcapsules rupture, the core material including the color former is released, the carrier oil flows, allowing the color former to interact and react with the developer particles to provide a colored mark. If the microcapsules remain intact and do not rupture, then no color change occurs, and the surface containing the coating remains unchanged.

(i) Microcapsules

The composition includes microcapsules having a cross-linked polymer shell and a core surrounded by the shell. The microcapsules may be formed by microencapsulation. Microencapsulation is a process in which tiny particles or droplets are surrounded by a coating to create small capsules around the droplets. Thus, in a relatively simplistic form, a microcapsule is a small sphere with a wall around it. The substance that is encapsulated may be called the core material, the active ingredient or agent, fill, payload, nucleus, or internal phase. Substances may be microencapsulated with the intention that the core material be confined within capsule walls unless certain external conditions trigger the capsule walls to rupture, break, or the like, as in the case here when a pressure or force is applied to rupture the capsules. The material encapsulating the core is referred to as the coating, membrane, encapsulation layer, shell, or wall material. Microcapsules may have one wall or multiple shells arranged in strata of varying thicknesses around the core.

A number of microencapsulation techniques (e.g., interfacial polymerization, “in situ” polymerization, coacervation, etc.) can be employed to form an encapsulation layer or shell around the color former composition thereby creating a core where the color former resides. The selection of the technique and shell material depends on the final application of the product, considering physical and chemical stability, concentration, desired particle size, release mechanism, and manufacturing costs. As an example, a cross-linking polymerization reaction between a cross-linkable component and an activator compound is employed in an emulsion environment. Interfacial cross-linking polymerization techniques are particularly preferred in certain aspects of the present invention. Such systems include gelatin, formaldehyde systems (phenol-formaldehyde or melamine-formaldehyde resins) and polyurethane-urea systems. Polyurethane-urea systems are useful for encapsulating the color former compositions according to aspects of the present invention. Preferred polyurethane-urea systems include, for example, the reaction of diisocyanates such as, for example, hexamethylene diisocyanate with a cross-linking activator compound such as, for example, polyamines like guanidene carbonate or diethyltriamine. A microencapsulation procedure is disclosed by Rodrigues et al., Microencapsulation of Limonene for Textile Application, Ind. Eng. Chem. Res., 2008, 47, 4142-4147, which is incorporated herein by reference in its entirety. Another microencapsulation procedure is disclosed in U.S. Pat. No. 5,635,211, which is incorporated herein by reference in its entirety.

A preferred microencapsulation method in the context of the present patent document involves an interfacial polymerization employing an oil-in-water emulsion. Interfacial polymerization (IFP) is characterized by wall formation via the rapid polymerization of monomers at the surface of the droplets or particles of dispersed core material. A multifunctional monomer is dissolved in the core material, and this solution is dispersed in an aqueous phase. A reactant to the monomer is added to the aqueous phase, and polymerization quickly ensues at the surfaces of the core droplets, forming the capsule walls.

The cross-linked polymer shell may be comprised of any suitable polymer, such as polyurea, polyurethane, polyamine, or other cross-linked polymers. In an exemplary embodiment, the cross-linked polymer shell is formed of a polyurea shell. Microcapsules having walls made of polyurea may be prepared by a two-phase polyaddition process. To this end, an oil phase containing an organic water-immiscible inert solvent, a first prepolymer, such as an isocyanate, and the material to be encapsulated (namely, the color former) is emulsified in an aqueous phase containing water and, if desired, additives such as emulsifiers, stabilizers and/or materials for preventing coalescence. For example, a suitable emulsion stabilizer may include polyvinyl alcohol. The addition of a second prepolymer, such as a polyamine or an amino alcohol, to this emulsion initiates a polyaddition reaction of amino and/or hydroxyl groups with isocyanate groups at the interface between oil droplets and water phase. As a result, the oil droplets are enveloped by a polyurea or polyurea/polyurethane wall. This gives a dispersion of microcapsules containing the material to be encapsulated and the organic solvent. The size of the microcapsules is approximately equal to the size of the emulsified oil droplets. As used herein, the term “prepolymer” refers to a chemical component that is capable of reacting with at least one other prepolymer or another of its kind as to allow formation of the polymer. In the case of polyurea containing microcapsule shells, at least one first prepolymer may be selected from the group consisting of an isocyanate, a diisocyanate, a polyisocyanate, and mixtures thereof. According to an embodiment of the present patent document, at least one first prepolymer is a C8-20 bis-isocyanate. Specific but non-limiting examples of such bis-isocyanates include isophorone diisocyanate (IPDI), hexamethylene diisocyanate (HDI), toluenediisocyanate (TDI), methylene-bis-(4-cyclohexylisocynate) (HMDI), xylene diisocynate (XDI), methylene diphenyl diisocynate (MDI), and mixtures thereof.

The second prepolymer may also be referred to herein as a “crosslinker.” Suitable cross linkers include amines, such as aliphatic primary, secondary, or tertiary amines including, but not limited to, 1,2-ethylene diamine, bis-(3-aminopropyl)-amine, hydrazine, hydrazine-2-ethanol, bis-(2-methylaminoethyl)-methyl amine, 1,4-diaminocyclohexane, 3-amino-1-methylaminopropane, N-hydroxyethyl ethylene diamine, N-methyl-bis-(3-aminopropyl)-amine, 1,4-diamino-n-butane, 1,6-diamino-n-hexane, 1,2-ethylene diamine-N-ethane sulphonic acid (in the form of an alkali metal salt), 1-aminoethyl-1,2-ethylene diamine,bis-(N,N-aminoethyl)-1,2-ethylene diamine, and diethylenetriamine. Hydrazine and its salts are also regarded as diamines in the present context.

Other suitable amines for use as the second prepolymer include guanidine compounds, such as guanidine compounds have at least two functional groups. Examples of guanidine compounds which are suitable for preparing the microcapsules may include those of the formula (I):

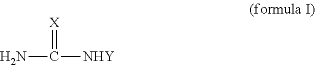

in which X represents HN═,

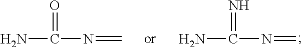

and Y represents H—, NC—, HO—,

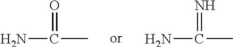

and salts thereof with acids.

For example, the salts can be salts of carbonic acid, nitric acid, sulphuric acid, hydrochloric acid, silicic acid, phosphoric acid, formic acid and/or acetic acid. Salts of guanidine compounds of the formula (I) can be used in combination with inorganic bases in order to obtain the free guanidine compounds of the formula (I) in situ from the salts. Examples of inorganic bases which are suitable for this purpose are alkali metal hydroxides and/or alkaline earth metal hydroxides and/or alkaline earth metal oxides. Preference is given to aqueous solutions or slurries of these bases, in particular to aqueous sodium hydroxide solutions, aqueous potassium hydroxide solutions and aqueous solutions or slurries of calcium hydroxide. Combinations of a plurality of bases can also be used.

The microcapsules may be produced by continuous and batchwise methods. The continuous procedure can be wherein, for example, an emulsion of the desired type and oil droplet size is produced continuously in an emulsifying machine by the flow-through method. This can be followed by continuous addition of an aqueous solution of the amine in a downstream reaction vessel. The batchwise procedure can be one in which, for example, the aqueous amine solution is added to an emulsion containing oil droplets having approximately the size of the desired microcapsules at the desired temperature in such an amount as is required stoichiometrically for the reaction of all isocyanate groups present in the oil phase.

Once formed, the microcapsules include the core completely surrounded by the polymer shell. The core may be comprised of at least one color former dissolved in a carrier oil. The color former may include leuco dyes, for example. The term “leuco dye” is used herein to refer to a color forming substance that is colorless or colored in a non-activated state and produces or changes color in an activated state. The terms “developer” or “activator” refer to substances that react with the leuco dye and cause the dye to alter its chemical structure and change or acquire color.

The leuco dyes may include, for example, triphenylmethanephthalideleuco compounds, triallylmethane leuco compounds, fluoran leuco compounds, phenothiazineleuco compounds, thiofluoran leuco compounds, xanthene leuco compounds, indophthalyl leucocompounds, spiropyran leuco compounds, azaphthalide leuco compounds, couromeno-pyrazoleleuco compounds, methine leuco compounds, rhodamineanilino-lactam leuco compounds, rhodaminelactam leuco compounds, quinazoline leuco compounds, diazaxanthene leucocompounds, and bislactone leuco compounds. Fluoran compounds, and in particular, aminofluorane compounds, may be particularly preferred.

The leuco dyes may be activated to change to any color. In particular, leuco dyes which react to form black dyes, yellow dyes, orange dyes, brown dyes, red dyes, purple dyes, blue dyes, green dyes, fluorescent dyes, and the like may be selected. In an exemplary embodiment, a leuco dye, which reacts to form an orange color, is used to distinguish from the other colors typically used on a golf club or other surface.

The leuco dye is preferably dissolved or dispersed in a carrier oil. The carrier oil may include oils, such as mineral oil, baby oil, vegetable oils, avocado oil, jojoba oil, borage oil, canola oil, castor oil, chamomile, coconut oil, corn oil, cottonseed oil, evening primrose oil, safflower oil, sunflower oil, soybean oil, sweet almond, lanolin, partially hydrogenated vegetable oils, and the like. In an exemplary embodiment, the carrier oil includes a vegetable oil, a soybean oil, or a mixture thereof. For example, the carrier oil may include a methylated soybean oil.

The core may include other ingredients, which may be present due to the microencapsulation process used, such as emulsifiers, stabilizers and/or materials for preventing coalescence. The core may also include other additives, which may be useful in enhancing the performance of the color former, its dispersability, its coating performance or transport on the surface, or the like. The core may also include other additives, which influence other properties of the coating, such as scent, odor, color, and the like.

The microcapsules are preferably of a size and thickness designed to remain intact under normal handling, but able to easily rupture when a sufficient force is applied to the microcapsules. For example, the microcapsules may have a diameter of about 2-8 microns, 3-7 microns, 4-6 microns, and in particular, about 5 microns. The wall thickness of the microcapsules may be greater than about 60 nanometers, which is suitable to exhibit a sufficient rupture strength to allow for the microcapsules to remain intact during normal handling, but which rupture when a severe force is applied to the surface. In particular, a sufficient rupture strength may be exhibited when the wall thickness of the microcapsules ranges from about 60-150 nanometers, about 70-140 nanometers, about 80-130 nanometers, about 90-130 nanometers, about 100-130 nanometers, and particularly, about 110-120 nanometers.

In another embodiment, the wall thickness and rupture strength vary depending on the color former such that the user can determine the force of contact between the coated device and the impacted object. In such cases, one color such as yellow would be associated with impact of low relatively low force, orange with higher impact force, and red with very high impact force. In other cases the ranges of impact force would be color coded to specific ranges of force measurements such as pounds per square inch. This is useful, for example, on sporting equipment, helmets, boxing gloves, karate targets, protective gear and even fabric. In the case of helmets, for example, this method provides information correlating to potential health hazards, injury, concussion, and potential traumatic encephalopathy, as well as need for helmet replacement. Such embodiments have broad uses in sports and also extending to safety equipment, and emergency personal and military applications, to indicate not only precisely where an impact has occurred but also a color-based visual indication as to the force of the impact.

In certain applications, the color change may be intentionally designed to be visible only under electromagnetic energy fields or visible light of certain wavelengths. In other embodiments, the dyes and developer compounds may be chosen to luminesce.

The microcapsules may be present in the coating composition in any suitable amount necessary to provide for uniform and adequate coverage of the microcapsules once applied to the surface. For example, the coating may contain about 1-50% by weight, about 5-40% by weight, bout 10-30% by weight, about 15-25% by weight, and more particularly, about 18-22% by weight of the microcapsules.

(ii) Developer

The second part of the coating includes developer components, which are capable of reacting with the color former, carried within the cores of the microcapsules, to cause a change or acquisition of color. The developer may include any chemical developers capable of reacting with the color former contained inside the microcapsules to produce a color image.

The developer materials or particles can be selected from among developers including acid clay, active clay, attapulgite, etc.; organic acids such as tannic acid, gallic acid, propylgallate; aromatic carboxylic acids such as benzoic acid, p-tert-butyl-benzoic acid, 4-methyl-3-nitro-benzoic acid, salicylic acid, 3-phenyl salicylic acid, 3- cyclohexyl salicylic acid,3-tert-butyl-5-methyl salicylic acid, 3,5-ditert-butyl salicylic acid, 3-methyl-5-benzyl salicylicacid, 3-phenyl-5-(a,a-dimethylbenzyl)salicylic acid, 3- cyclohexyl-5-(a,a-dimethylbenzyl)salicylic acid, 3-(a,a-dimethylbenzyl)-5-methyl salicylic acid, 3,5-dicyclohexylsalicylic acid, 3,5-di-(a-methylbenzyl)salicylic acid, 3,5-di-(a,a-dimethylbenzyl)salicylic acid,3-(a-methylbenzyl)-5-(a,a-dimethylbenzyl)salicylic acid, 4-methyl-5-cyclohexyl salicylic acid,2-hydroxy-1-benzyl-3-naphthoic acid, 1-benzoyl-2-hydroxy-3-naphthoic acid, 3-hydroxy-5-cyclohexyl-2-naphthoic acid and the like, and polyvalent metallic salts thereof such as zinc salts, aluminum salts, magnesium salts, calcium salts and cobalt salts; phenol compounds such as 6,6′-methylene-bis(4-chloro-m-cresol); acid polymers such as maleic acid-rosin resin and copolymers of maleic anhydride with styrene, ethylene or vinylmethylether; and aromatic carboxylic acid-aldehyde polymers, aromatic carboxylic acid-acetylene polymers and their polyvalent metallic salts.

Developer materials or particles may include phenolic resins, such as phenol-aldehyde resins (e.g., p-phenyl-pjienolformaldehyde resin); phenol-acetylene resins, (e.g., p-tert-butyl-phenoi-acetylene resin); polyvalent metallic salts thereof such as zinc modified phenol formaldehyde resin as disclosed in U.S. Pat. No. 3,732,120, and phenolic resins modified to include amounts of unsubstituted or substituted salicylic acids in a manner known in the art. The developer materials may include phenol-formaldehyde condensation products, alkylphenolic resins, and metallated products of alkylphenolic resins. The alkyl phenols may be monosubstituted by analkyl group which may contain 1 to 12 carbon atoms. Examples of alkyl phenols are ortho- orpara- substituted ethylphenol, propylphenol, butylphenol, amyl-phenol, hexylphenol, heptylphenol, octylphenol, nonylphenol, t-butylphenol, t-octylphenol, etc. Another class of developer materials include a resin-like condensation product of a polyvalent metal salt, such as a zinc salt, and a phenol, a phenol-formaldehyde condensation product, or a phenol-salicylic acid-formaldehyde condensation product. For example, the developer material may include a zinc salicylate. In an exemplary embodiment, the developer particles include a phenolic resin, such as a zincated phenolic resin.

The developer material or component may be in a particulate form. The terms “particle” or “particulate” are to be broadly interpreted to encompass those of various shapes, sizes, and/or textures which can include those that may have varying degrees of irregularities, disunifoimities, etc. or which may possess regular and/or uniform properties. The developer particles are in certain cases smaller in size than the microcapsules. For example, the diameter of the developer particles may be about 2 microns or less (e.g., about 0.01-2 microns or about 0.05-1.0 micron).

The developer particles may be present in the coating composition in any suitable amount to provide for uniform and adequate coverage of the developer particles once applied to the surface. For example, the coating may contain about 1-50% by weight, about 5-40% by weight, about 10-30% by weight, about 15-20% by weight, and more particularly, about 16-19% by weight of the developer particles.

Other Coating Constituents

The coating may further include other coating constituents. The coating may be colorless or colored, but is preferably colorless when applied to the surface and so long as the at least one color former is not in contact with the developer particles. Other constituents may include, for example, oils, flow enhancers, resins, and the like. Other additives, such as flow enhancers, emulsion stabilizers, and the like may be added in suitable amounts known in the art. If present, such additives may include less than about 10% by weight, less than 5% by weight, or less than 1% by weight.

Preparing the Coating

The percent solids and content of oil, active developer, and capsules may be of a suitable amount to obtain the desired coating composition. In one embodiment, the microcapsule slurry preferably contains at least 40% solids. In particular, the microcapsule slurry may contain about 40-80% solids, preferably, about 40-60% solids, more preferably, about 46-50% solids, and most preferably, about 48% solids. The total active developer used can vary, for example, between about 10% to about 18%, preferably being at about 14%, and the total active capsule content can vary, for example, between about 10% to about 20%, preferably being at about 15%.

### EXAMPLE

The following example is intended to be illustrative and not limiting. A coating was prepared according to the following method. First, microcapsules having walls made of polyurea were prepared by a two-phase polyaddition process using the ingredients identified in Table 1.

TABLE 1

| Material | % by weight |
|---|---|
| Polyvinyl alcohol (PVA) | 1.1 |
| Poly-isocyanate | 14.5 |
| Guanadine carbonate | 8.0 |
| Soy oil | 71.0 |
| Color formers (combination of | 5.4 |
| two leuco dyes) | |

After the microcapsules were formed, they were incorporated with a coating composition including the ingredients identified in Table 2, by mixing the two compositions together.

TABLE 2

| Material | % by weight |
|---|---|
| Polyurea microcapsules | 20.8 |
| Pigment | 53 |
| Binder | 8 |
| Developer | 17 |
| Other additives | 1.2 |

Although the embodiments have been described with reference to the drawings and specific examples, it will readily be appreciated by those skilled in the art that many modifications and adaptations of the compositions, devices, and processes described herein are possible without departure from the spirit and scope of the embodiments as claimed. Thus, it is to be clearly understood that this description is made only by way of example and not as a limitation on the scope.

1. An impact indicator composition, comprising:
microcapsules having a cross-linked polyurea shell and a core surrounded by the shell, wherein the polyurea shell comprises at least one isocyanate and at least one polyamine, and the core comprises at least one color former; and
a developer capable of activating the color former when in contact therewith;
wherein the microcapsules are configured to remain intact during application upon a first surface to be coated, and to rupture upon impact between the first surface and another surface thereby releasing the color former to contact the developer and provide a visual indication of location of the impact.

2. An impact indicator composition according to claim 1 wherein the microcapsules have a diameter of about 2-8 microns.

3. An impact indicator composition according to claim 1 wherein the microcapsules have a wall thickness of about 110-120 nanometers.

4. An impact indicator composition according to claim 1 wherein the developer is in the form of particles.

5. An impact indicator composition according to claim 1 wherein the composition further comprises about 40-60% pigment.

6. An impact indicator composition according to claim 1 wherein the composition further comprises about 5-20% binder.

7. An impact indicator composition according to claim 1 wherein the developer comprises a phenolic resin.

8. An impact indicator composition according to claim 1 wherein the core comprises the at least one color former dissolved in a carrier oil.

9. An impact indicator composition according to claim 1 wherein the color former is a leuco dye.

10. An impact indicator composition according to claim 1 wherein the composition is an aqueous liquid comprising about 5 to 35% by weight microcapsules, wherein the core comprises at least one color former dissolved in a carrier oil; about 5 to 30% by weight developer particles; and about 3 to 30% binder; wherein the isocyanate comprises a bis-isocyanate and the polyamine comprises guanidine.

11. A device for precisely indicating an impact location, comprising:
a container; and
a liquid impact indicator composition within the container;
wherein the impact indicator composition comprises:
microcapsules having a cross-linked polyurea shell and a core surrounded by the shell, wherein the core comprises at least one color former in a carrier oil; and
a developer capable of activating the color former when in contact therewith.

12. A device according to claim 11, further comprising a pump or aerosol spray nozzle configured to spray the composition.

13. A device according to claim 12, wherein the impact indicator composition further comprises a foam control agent.

14. A device according to claim 11, wherein the developer comprises phenolic resin particles.

15. A device according to claim 11 wherein the core comprises the at least one color former dissolved in a carrier oil and the color former is a leuco dye.

16. A device according to claim 11, wherein the microcapsules have a diameter of about 2-8 microns and a wall thickness of about 110-120 nanometers.

17. A method of indicating a contact location, comprising:
applying an impact indicator composition to at least a portion of a first surface;
wherein the impact indicator composition comprises microcapsules having a cross-linked polyurea shell and a core surrounded by the shell, wherein the core comprises at least one color former dissolved in a carrier oil; and
developer particles capable of activating the color former when in contact therewith.

18. A method of indicating a contact location according to claim 17 where the applying is by spraying a coating of the composition on at least a portion of the first surface.

19. A method of indicating a contact location according to claim 17 comprising activating the impact indicator composition by causing or permitting an impact from a second surface on the first surface causing a visual color change to appear on the first surface.

20. A method according to claim 17 further comprising indicating a relative force of impact wherein the composition comprises a plurality of microcapsules carrying different color formers and being capable of rupturing at pre-determined impact forces.
